(19) United States
(12) Patent Application Publication
(10) Pub. No.: US 2014/0149646 A1
(43) Pub. Date: May 29, 2014

(54) MEMORY SYSTEMS INCLUDING FLASH MEMORIES, FIRST BUFFER MEMORIES, SECOND BUFFER MEMORIES AND MEMORY CONTROLLERS AND METHODS FOR OPERATING THE SAME

(71) Applicant: SAMSUNG ELECTRONICS CO., LTD., Suwon-Si (KR)

(72) Inventor: Kwangseok IM, Seoul (KR)

(73) Assignee: SAMSUNG ELECTRONICS CO., LTD., Suwon-Si (KR)

(21) Appl. No.: 14/088,936

(22) Filed: Nov. 25, 2013

(30) Foreign Application Priority Data
Nov. 26, 2012 (KR) 10-2012-0134580

(51) Int. Cl. G06F 12/02

(52) U.S. Cl. CPC G06F 12/0246
USPC 711/103

(57) ABSTRACT

One example embodiment of the inventive concepts is directed to provide an operating method of a memory system including a flash memory, a first buffer memory, a second buffer memory and a memory controller. The operating method includes reading data stored at the flash memory and generating an address corresponding to a region of the first buffer memory at which the read data is to be stored. The operating method further includes determining whether the second buffer memory is at an erase state and if the determining indicates that the second buffer memory is at an erase state, storing the read data at the second buffer memory and the generated address of the first buffer memory at an internal register.

### CROSS-REFERENCE TO RELATED APPLICATIONS

A claim for priority under 35 U.S.C. §119 is made to Korean Patent Application No. 10-2012-0134580 filed Nov. 26, 2012, in the Korean Intellectual Property Office, the entire contents of which are hereby incorporated by reference.

### BACKGROUND

The inventive concepts described herein relate to flash memory devices, and more particularly, to flash memory based memory systems and/or operating methods thereof.

A flash memory device may be one type of nonvolatile memory device. The flash memory device may provide a data access speed which is higher than a data access speed of a conventional hard disk drive. Also, size and power consumption of the flash memory device may be less than those of the conventional hard disk drive. Since the flash memory device is tolerant of external shocks, it may be widely used as a storage device for a portable device.

Also, since an operating speed of the flash memory device is slower than that of a central processing unit (CPU), a buffer memory may be used to compensate for a speed difference between the flash memory device and the CPU. In recent years, as interfaces for flash memory devices, memory controllers, and hosts have developed, improvement on the performance of such buffer memories may be required. In case of a dynamic random-access memory (DRAM) being used as a buffer memory, a flash memory based storage device may not perform optimally.

### SUMMARY

One example embodiment of the inventive concepts is directed to provide an operating method of a memory system including a flash memory, a first buffer memory, a second buffer memory and a memory controller. The operating method includes reading data stored at the flash memory and generating an address corresponding to a region of the first buffer memory at which the read data is to be stored. The operating method further includes determining whether the second buffer memory is at an erase state and if the determining indicates that the second buffer memory is at an erase state, storing the read data at the second buffer memory and the generated address of the first buffer memory at an internal register.

In yet another example embodiment, the operating method further includes, if the determining indicates that the second buffer memory is not at an erase state, storing the read data at a region of the first buffer memory corresponding to the stored address of the first buffer memory.

In yet another example embodiment, the operating method further includes receiving a read address from a host, comparing the read address and the stored address of the first buffer memory and transferring data corresponding to the read address to the host according to the comparing.

In yet another example embodiment, the transferring includes transferring data stored at the second buffer memory to the host, if the stored address of the first buffer memory is equal to the read address.

In yet another example embodiment, the transferring includes transferring data of the first buffer memory corresponding to the read address to the host, if the stored address of the first buffer memory is not equal to the read address.

In yet another example embodiment, if the second buffer memory is not accessed during a period of time, the method further includes flushing data stored at the second buffer memory to a region of the first buffer memory corresponding to the stored address of the first buffer memory.

In yet another example embodiment, an operating speed of the second buffer memory is higher than an operating speed of the first buffer memory.

In yet another example embodiment, the operating method further includes generating selection information indicating that the second buffer memory is at one of an erase state and a program state based on the determining.

In one example embodiment of the inventive concepts, a memory system includes a flash memory; a first buffer memory; and a memory controller configured to generate an address of the first buffer memory at which data read from the flash memory is to be stored. The memory controller includes a second buffer memory and a buffer manager. The memory controller is configured to generate selection information indicating whether the second buffer memory is at one of an erase state and a program state. The buffer manager is further configured to store the read data at one of the first buffer memory and the second buffer memory based on the selection information and store the generated address of the first buffer memory based on the selection information.

In yet another example embodiment, the memory controller is further configured to flush the data stored at the second buffer memory to a region of the first buffer memory corresponding to the stored address of the first buffer memory, when the second buffer memory is not accessed during a period of time.

In yet another example embodiment, the buffer manager includes a de-multiplexer configured to receive the generated address of the first buffer memory, the read data and the selection information. The de-multiplexer is further configured to select one of the first buffer memory and the second buffer memory based on at least the selection information. The buffer manager further includes a register configured to selectively store the address of the first buffer memory based on the selection information and a comparator configured to compare the address stored at the register with the read address. The buffer manager further includes a multiplexer configured to transfer data stored at the selected one of the first buffer memory and the second buffer memory to the host based on an output of the comparator.

In yet another example embodiment, the first buffer memory and the second buffer memory are formed of different types of random access memories.

In yet another example embodiment, an operating speed of the second buffer memory is higher than an operating speed of the first buffer memory.

In yet another example embodiment, the flash memory and the memory controller are connected via a plurality of channels and each of the first buffer memory and the second buffer memory includes a plurality of buffer memory units, each of the plurality of buffer memory units corresponding to one of the plurality of channels.

In yet another example embodiment, the memory controller is connected with a host based on a peripheral component interconnection-express (PCI-E) based interface.

In one example embodiment, a method includes determining, for a memory system comprising a first buffer memory and a second buffer memory, a state of the second buffer memory and designating at least one of the first buffer memory and the second buffer memory for storing data based on the determined state of the second buffer memory.

In yet another example embodiment, the method further includes receiving a read data request from a host and reading data corresponding to the received read data request from a flash memory.

In yet another example embodiment, the method further includes generating an address at the first buffer memory for storing the read data.

In yet another example embodiment, the determining the state of the second buffer memory includes generating selecting information indicating whether the second buffer memory is at an erase state

In yet another example embodiment, the determining determines that the second buffer memory is at the erase state if the generated selection information is a logical 1.

In yet another example embodiment, the designating designates the second buffer memory for storing the read data, if the generated selection information indicates that the second buffer memory is at the erase state.

In yet another example embodiment, upon designating the second buffer memory for storing the read data, the method further includes determining an amount of time since the host last accessed the second buffer memory and flushing the data stored in the second buffer memory to a region of the first buffer memory corresponding to the generated address of the first buffer memory.

In yet another example embodiment, the method further includes receiving the generated address of the first buffer memory, the read data and the generated selection information and selecting at least one of the first buffer memory and the second buffer memory based on at least the generated selection information. The method further includes selectively storing, at a register, the address of the first buffer memory based on the generated selection information, comparing the selectively stored address with an address associated with the read data and transferring data stored at the selected one of the first buffer memory and the second buffer memory, to the host based on the comparing.

In yet another example embodiment, the first buffer memory and the second buffer memory are formed of different types of random access memories.

In yet another example embodiment, an operating speed of the second buffer memory is higher than an operating speed of the first buffer memory.

### BRIEF DESCRIPTION OF THE DRAWINGS

The above and other objects and features will become apparent from the following description with reference to the following figures, wherein like reference numerals refer to like parts throughout the various figures unless otherwise specified, and wherein

FIG. 1 is a block diagram schematically illustrating a computing system based on a flash memory, according to an example embodiment of the inventive concepts;

FIG. 2 is a flowchart schematically illustrating an operating method of a memory controller in FIG. 1, according to an example embodiment;

FIG. 3 is a diagram schematically illustrating a physical structure of first and second buffer memories in FIG. 1, according to an example embodiment;

FIGS. 4A and 4B are diagrams for describing an operating method of a memory controller in FIG. 1, according to an example embodiment;

FIGS. 5A and 5B are diagrams for describing an operating method of a memory controller, according to an example embodiment of the inventive concepts;

FIG. 6 is a block diagram schematically illustrating first and second buffer memories and a buffer manager, according to an example embodiment of the inventive concepts;

FIG. 7 is a block diagram schematically illustrating a buffer manager corresponding to a plurality of channels, according to an example embodiment of the inventive concepts; and

FIG. 8 is a block diagram schematically illustrating storage, according to an example embodiment of the inventive concepts.

### DETAILED DESCRIPTION OF EXAMPLE EMBODIMENTS

Some example embodiments will be described in detail with reference to the accompanying drawings. The inventive concepts, however, may be embodied in various different forms, and should not be construed as being limited only to the described example embodiments. Rather, these embodiments are provided as examples so that this disclosure will be thorough and complete, and will fully convey the inventive concepts to those skilled in the art. Accordingly, known processes, elements, and techniques are not described with respect to some of the example embodiments of the inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which the inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

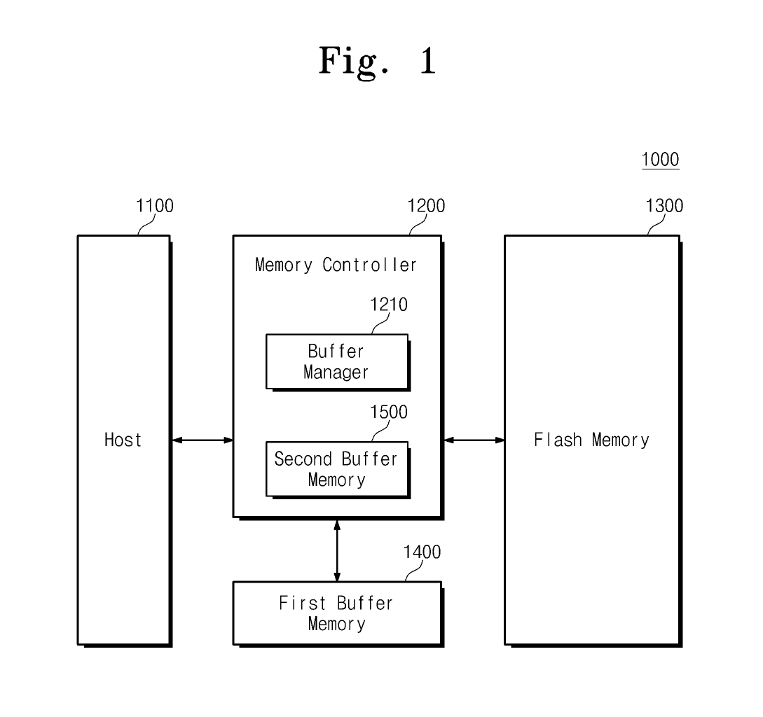

FIG. 1 is a block diagram schematically illustrating a flash memory based computing system, according to an example embodiment of the inventive concepts.

Referring to FIG. 1, a computing system 1000 may include a host 1100, a memory controller 1200, a flash memory 1300, and a first buffer memory 1400. Each of the components 1100 to 1400 of the computing system 1000 may be embodied as a chip, a module, a device or integrated in a device. Also, the components 1200 to 1400 of the computing system 1000 may be implemented in a device to be connected with the host 1100.

The host 1100 may transfer a read or write request to the memory controller 1200 using a file system. The memory controller 1200 may control the flash memory 1300 in response to the read or write request. In one example embodiment, when the memory controller 1200 receives a read request, the memory controller 1200 may read target data corresponding to the read request from the flash memory 1300 and store the read data at the first buffer memory 1400. The memory controller 1200 may send data stored at the first buffer memory 1400 to the host 1100.

In one example embodiment, the host 1100 and the memory controller 1200 may exchange data based on known protocol. For example, the host 1100 and the memory controller 1200 may exchange data based on at least one of a plurality of interface protocols such as a Universal Serial Bus (USB) protocol, an Multimedia Card (MMC) protocol, a Peripheral Component Interconnection (PCI) protocol, a PCI-express (PCI-E) protocol, an Advanced Technology Attachment (ATA) protocol, a serial-ATA protocol, a parallel-ATA protocol, a Small Computer System Interface (SCSI) protocol, an Enhanced Small Disk Interface (ESDI) protocol, an Integrated Drive Electronics (IDE) protocol, etc.

The memory controller 1200 may include a buffer manager 1210 and a second buffer memory 1500. In one example embodiment, the memory controller 1200 may read data of the flash memory 1300. The memory controller 1200 may generate an address corresponding to a region where the read data is to be stored at the first buffer memory 1400.

The buffer manager 1210 may select the first buffer memory 1400 or the second buffer memory 1500 to store data read from the flash memory 1300. In one example embodiment, the buffer manager 1210 may be implemented as hardware or software.

The second buffer memory 1500 may be a working memory of the memory controller 1200. The second buffer memory 1500 may be used as a buffer memory between the host 1100 and flash memory 1300. The second buffer memory 1500 may be one of a DRAM, a synchronous DRAM, a static random-access memory (SRAM), a Double Date Rate (DDR) synchronous dynamic random-access memory (SDRAM), a DDR2 SDRAM, a DDR3 SDRAM, a phase change random-access memory (PRAM), a magnetic random-access memory (MRAM), a resistive random-access memory (RRAM), etc.

The flash memory 1300 may include a plurality of memory blocks each having a plurality of pages. The flash memory 1300 may perform writing, reading or erasing on the memory blocks according to a control of the memory controller 1200. The flash memory 1300 may be connected with the memory controller 1200 through a plurality of channels. The plurality of channels may be connected with the plurality of memory blocks, respectively. Each of the plurality of memory blocks may be connected to the plurality of channels via the same data bus.

The first buffer memory 1400 may be also used as a buffer memory between the host 1100 and the flash memory 1300. For example, the memory controller 1200 may store data read from the flash memory 1300 at the first buffer memory 1400. The first buffer memory 1400 may be formed of one of a DRAM, an SDRAM, an SRAM, a DDR SDRAM, a DDR2 SDRAM, a DDR3 SDRAM, a PRAM, an MRAM, an RRAM, etc.

In one example embodiment, a storage capacity of the first buffer memory 1400 may be relatively larger than that of the second buffer memory 1500 and an operating speed of the first buffer memory 1400 may be relatively slower than that of the second buffer memory 1500.

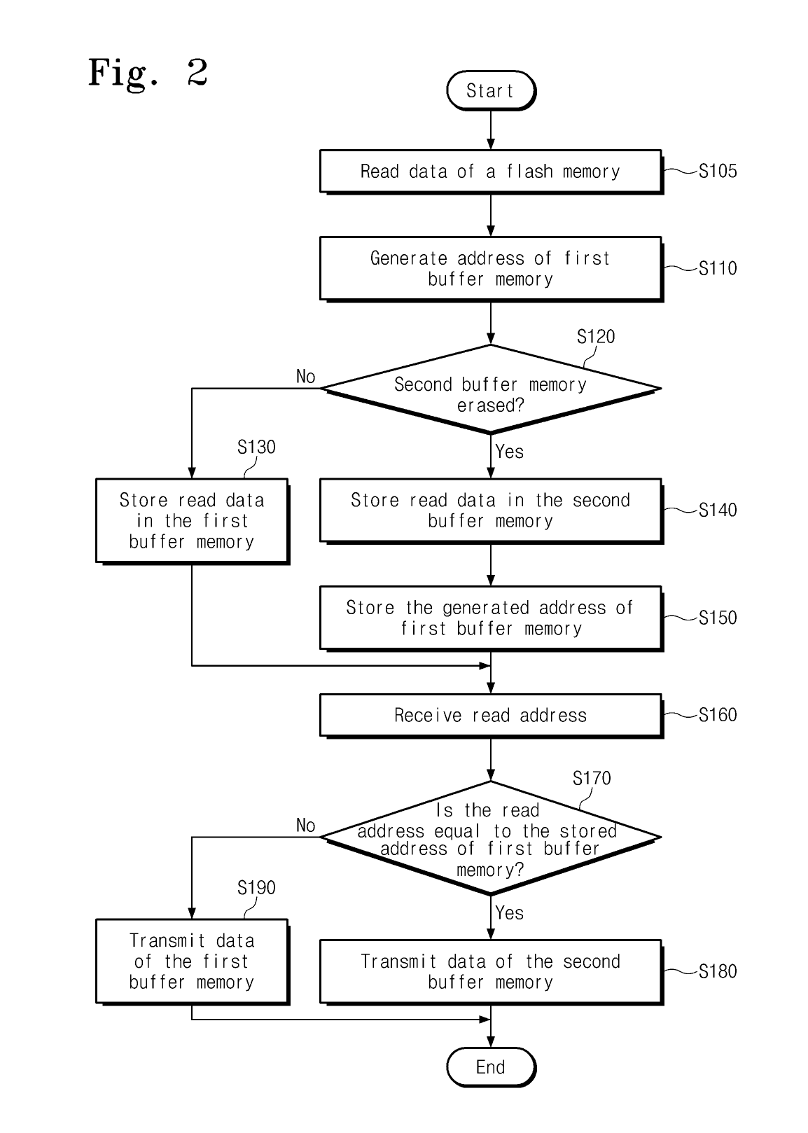

FIG. 2 is a flowchart schematically illustrating an operating method of a memory controller in FIG. 1, according to an example embodiment.

Referring to FIG. 2, at S105, a memory controller 1200 may read data stored at a flash memory 1300. For example, the memory controller may receive a read request from a host 1100. in one example embodiment, the flash memory 1300 may include a plurality of pages. The memory controller 1200 may read data stored at one or more pages of the plurality of pages in the flash memory 1300 in response to the received read request.

At S110, the memory controller 1200 may generate an address corresponding to a region of a first buffer memory 1400 where the data read from the flash memory 1300 is to be stored.

At S120, the memory controller 1200 may determine whether a second buffer memory 1500 included in the memory controller 1200 is at an erase state. In one example embodiment, the memory controller 1200 may generate selection information indicating whether the second buffer memory 1500 is at an erase state or at a program state.

If at S120, the second buffer memory 1500 is determined not to be at an erase state, at S130, the memory controller 1200 may store the read data at the first buffer memory 1400.

If at S120, the second buffer memory 1500 is determined to be at an erase state, at S140, the memory controller 1200 may store the read data at the second buffer memory 1500.

At S150, the memory controller 1200 may store the address of the first buffer memory 1400, generated at S110.

At S160, the memory controller 1200 may receive a read address from the host 1100. In one example embodiment, the memory controller 1200 may convert the input read address into an address of the first buffer memory 1400.

At S170, the memory controller 1200 may compare the read address with the stored address of the first buffer memory 1400.

If the read address is equal to the stored address of the first buffer memory 1400, at S180, the memory controller 1200 may send the data stored at the second buffer memory 1500 to the host 1100.

If the read address is not equal to the stored address of the first buffer memory 1400, at S190, the memory controller 1200 may send the data stored at the first buffer memory 1400 to the host 1100.

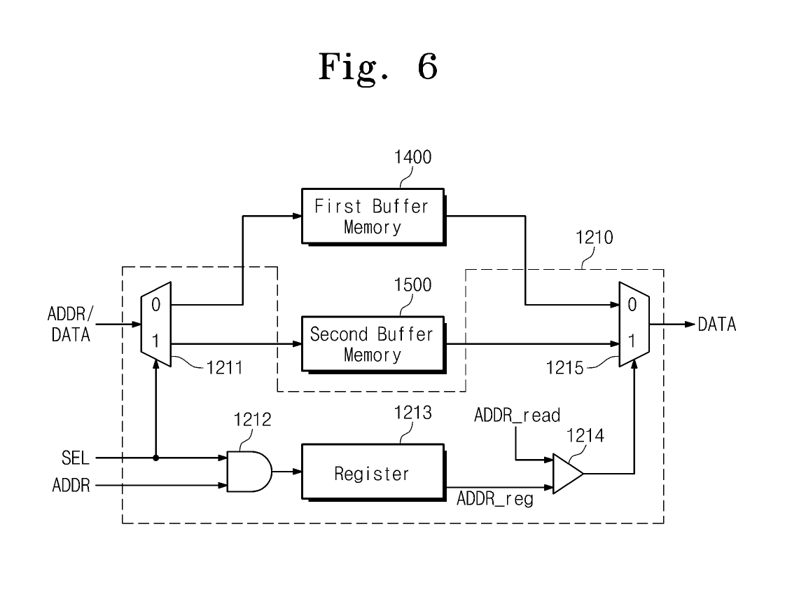

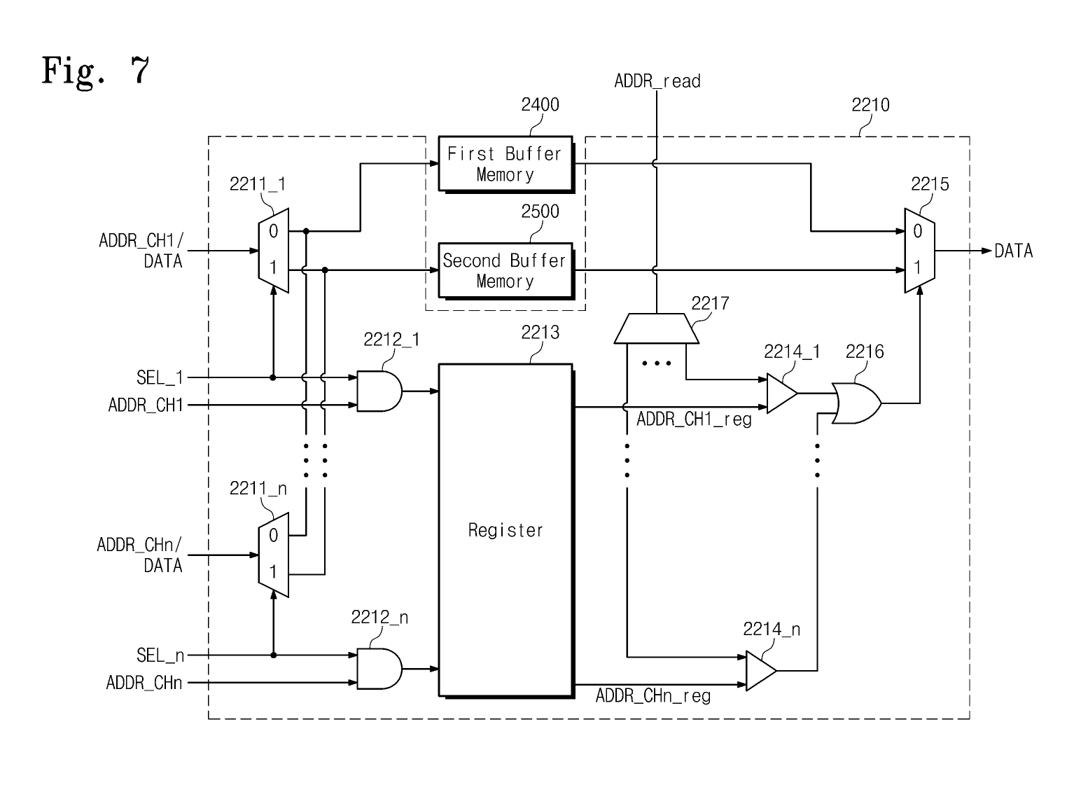

An operating method of the memory controller 1200 will be more fully described with reference to FIGS. 6 and 7.

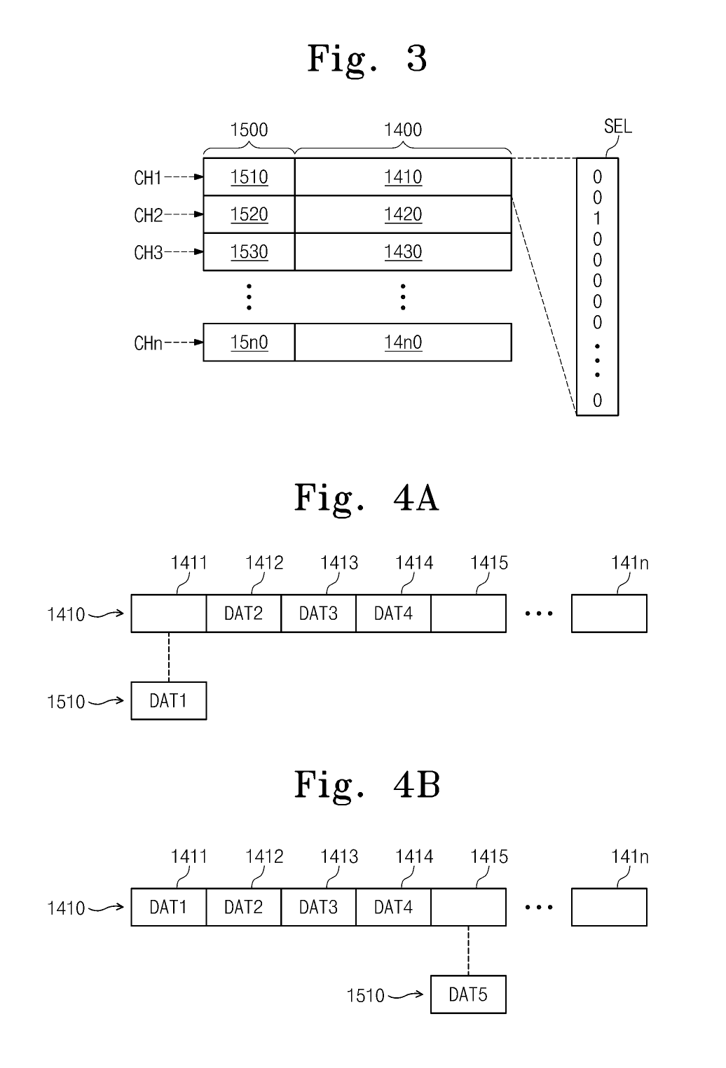

FIG. 3 is a diagram schematically illustrating a physical structure of first and second buffer memories in FIG. 1, according to an example embodiment. Referring to FIG. 3, the flash memory 1300 may be connected with the memory controller 1200 through n channels CH1 to CHn. The first and second buffer memories 1400 and 1500 may be configured to correspond to the plurality of channels. For example, the first buffer memory 1400 may include a plurality of first buffer memory units 1410 to 14n0 each corresponding to the plurality of channels CH1 to CHn. The second buffer memory 1500 may include a plurality of second buffer memory units 1510 to 15n0 each corresponding to the plurality of channels CH1 to CHn.

In one example embodiment, the first buffer memory units 1410 to 14n0 may operate independently through corresponding channels. In one example embodiment, the second buffer memory units 1510 to 15n0 may operate independently through corresponding channels.

The memory controller 1200 may generate selection information SEL corresponding to the plurality of channels, respectively. The selection information SEL may be information indicating whether the second buffer memory 1500 is at an erase state or at a program state. Since the second buffer memory 1500 has data storage priority over the first buffer memory 1400, the selection information SEL may be information indicating whether data read from the flash memory 1300 is stored at the first buffer memory 1400 or at the second buffer memory 1500.

For example, pages of memory blocks in the flash memory 1300 may have a size of 8 KB, respectively. A first buffer memory unit 1410 corresponding to a first channel may have a capacity of 1 MB. The first buffer memory unit 1410 may be formed of 128 sectors. Each sector may have a size of 8 KB. The second buffer memory unit 1510 may have a size of 8 KB. The selection information SEL may be formed of 128 bits. In one example embodiment, a second buffer memory unit 1510 may correspond to a third sector of sectors in the first buffer memory unit 1410. Accordingly, if the data read from the flash memory 1300 is stored at the second buffer memory unit 1510, the memory controller 1200 may set a third bit value of the selection information SEL to “data 1”.

In example embodiments, if data stored at the second buffer memory unit 1510 is erased or flushed into a third sector of the first buffer memory 1400, the memory controller 1200 may set the third bit value of the selection information SEL to a “data 0”.

FIGS. 4A and 4B are diagrams for describing an operating method of a memory controller in FIG. 1, according to an example embodiment of the inventive concepts. In example embodiments, a memory controller 1200 may read first to fifth data DAT1, DAT2, DAT3, DAT4, and DAT5 from a flash memory 1300 in this order. A first buffer memory unit 1410 may be formed of 128 sectors. Each sector may have a size of 8 KB. The second buffer memory unit 1510 may have a size of 8 KB. A second buffer memory unit 1510 may correspond to one of sectors in the first buffer memory unit 1410.

Referring to FIG. 4A, the memory controller 1200 may read the first data DAT1 from the flash memory 1300. The second buffer memory unit 1510 may be at an erase state. The second buffer memory unit 1510 may correspond to a first sector 1411 of the first buffer memory unit 1410. The memory controller 1200 may store the first data DAT1 at the second buffer memory unit 1510.

The memory controller 1200 may sequentially read the second to fourth data DAT2, DAT3 and DAT4 from the flash memory 1300. The memory controller 1200 may store the second to fourth data DAT2, DAT3 and DAT4 at the remaining sectors 1412 to 1414 of the first buffer memory unit 1410 other than the first sector 1411, respectively.

The memory controller 1200 may generate selection information SEL. Since the second buffer memory unit 1510 at which the first data DAT1 is stored corresponds to the first sector 1411 of the first buffer memory unit 1410, the memory controller 1200 may set a first bit value of the selection information SEL to “data 1”.

Referring to FIG. 4B, if a host 1100 does not access the second buffer memory unit 1510 during a given period of time, the memory controller 1200 may flush the first data DAT1 stored at the second buffer memory unit 1510 into a first sector of the first buffer memory unit 1410. The memory controller 1200 may set a first bit value of the selection information SEL to “data 0”. In one example embodiment, the given period of time may be user specified and/or may be determined based on empirical studies.

Thereafter, the memory controller 1200 may read fifth data DAT5. In this case, since the second buffer memory unit 1510 is at an erase state, the memory controller 1200 may store the fifth data DAT5 at the second buffer memory unit 1510. The memory controller 1200 may set a fifth bit value of the selection information SEL to “data 0”.

According to the above-described example embodiments of the inventive concepts, an operating speed of the second buffer memory unit 1510 may be faster than that of the first buffer memory unit 1410. Also, since the second buffer memory unit 1510 has data storage priority over the first buffer memory unit 1410, the probability that the second buffer memory unit 1510 is accessed may be high. Thus, the speed of a flash memory based memory system may be improved.

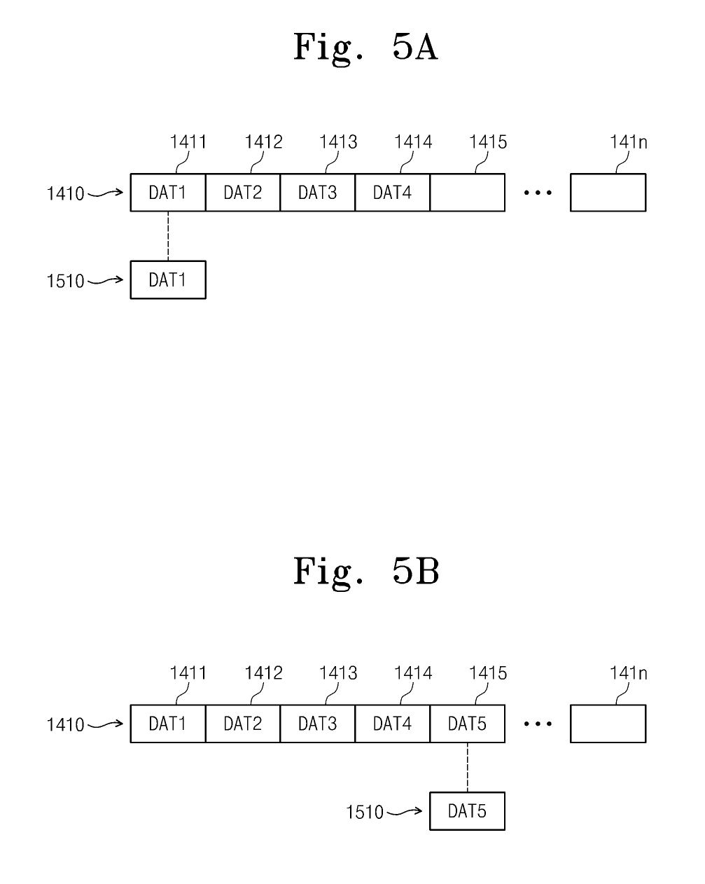

FIGS. 5A and 5B are diagrams for describing an operating method of a memory controller, according to an example embodiment of the inventive concepts. Sectors 1411 to 1415 of a first memory unit 1410, a second memory unit 1510 and first to fifth data DAT1 to DAT5 may be substantially the same as described with reference to FIGS. 4A and 4B, and a description thereof is thus omitted.

Referring to FIG. 5A, a memory controller 1200 may read first data DAT1. A second buffer memory unit 1510 may be at an erase state. The second buffer memory unit 1510 may correspond to a first sector 1411 of a first buffer memory unit 1410. Thus, the memory controller 1200 may store the first data DAT1 at the second buffer memory unit 1510 and the first sector 1411 of the first buffer memory unit 1410.

Thereafter, the memory controller 1200 may sequentially read second to fourth data DAT2, DAT3 and DAT4. Since the first data DAT1 is stored at the second buffer memory unit 1510, the memory controller 1200 may sequentially store the second to fourth data DAT2, DAT3 and DAT4 at the first buffer memory unit 1410. In one example embodiment, the memory controller 1200 may set a first bit value of selection information SEL to “data 1”.

Referring to FIG. 5B, if a host 1100 does not access the first data DAT1 during a given period of time, the memory controller 1200 may erase the first data DAT1 stored at the second buffer memory unit 1510. In one example embodiment, the memory controller 1200 may set a first bit value of the selection information SEL to “data 0”. In one example embodiment, the given period of time may be user specified and/or may be determined based on empirical studies.

Thereafter, the memory controller 1200 may read fifth data DAT5. In this case, the memory controller 1200 may store fifth data DAT5 at the second buffer memory unit 1510 being at an erase state and at a fifth sector 1415 of the first buffer memory unit 1410. In one example embodiment, the memory controller 1200 may set a fifth bit value of the selection information SEL to a logically high level.

In one example embodiment of the inventive concepts, a second buffer memory may have an operating speed faster than that of a first buffer memory and a priority for storing data compared to the first buffer memory. Thus, as the probability that an access to the second buffer memory increases becomes high, an operating speed of a memory system may be improved.

FIG. 6 is a block diagram schematically illustrating first and second buffer memories and a buffer manager, according to an example embodiment of the inventive concepts. In one example embodiment, a memory controller 1200 of FIG. 1 may receive a logical address from a host 1100 and convert the input logical address into an address ADDR of a first buffer memory 1400 and a read address ADDR_read. The address ADDR and the read address ADDR_read of FIG. 6 may be addresses of the first buffer memory 1400. For ease of description, components unnecessary to describe an operation of a buffer manager 1210 may be skipped.

Referring to FIG. 6, the buffer manager 1210 may receive selection information SEL, a first buffer memory address ADDR and data from a memory controller 1200. The buffer manager 1210 may include a de-multiplexer 1211, an AND gate 1212, a register 1213, a comparator 1214, and a multiplexer 1215.

The de-multiplexer 1211 may receive an address of the first buffer memory 1400 and data and select a data path to be connected with one of first and second buffer memories 1400 and 1500 based on selection information SEL. For example, if the input address and data are stored at the second buffer memory 1500, the selection information SEL may have a logically high level. The de-multiplexer 1211 may select a data path to be connected with the second buffer memory 1500 based on the selection information SEL.

The AND gate 1212 may receive the selection information SEL and the address ADDR of the first buffer memory 1400 to compare the input selection information SEL with the address ADDR of the first buffer memory 1400. For example, in a case where the selection information SEL has a logically high level, the AND gate 1212 may transfer the address ADDR to the register 1213. On the other hand, in a case where the selection information SEL has a logically low level, the address ADDR may not be sent to the register 1213 through the AND gate 1212.

The register 1213 may receive an output of the AND gate 1212 to selectively store the address ADDR of the first buffer memory 1400. For example, in a case where the selection information SEL has a logically high level, the register 1213 may store the address ADDR transferred from the AND gate 1212.

The comparator 1214 may compare an address ADDR_reg stored at the register 1213 with the read address ADDR_read received from the memory controller 1200. If the stored address ADDR_reg is equal to the read address ADDR_read, the comparator 1214 may output a high-level signal. If the stored address ADDR_reg is not equal to the read address ADDR_read, the comparator 1214 may output a low-level signal.

The multiplexer 1215 may receive an output of the comparator 1214, and may output data stored at one of the first and second buffer memories 1400 and 1500 based on the output of the comparator 1214. For example, if the output of the comparator 1214 has a logically high level, data corresponding to the read address ADDR_read may be stored at the second buffer memory 1500. Thus, the multiplexer 1215 may output data of the second buffer memory 1500. If the output of the comparator 1214 has a logically low level, data corresponding to the read address ADDR_read may be stored at the first buffer memory 1400. Thus, the multiplexer 1215 may output data, corresponding to the read address ADDR_read, from among data stored at the first buffer memory 1400.

With the above description, the buffer manager 1210 may manage the first and second buffer memories 1400 and 1500 by selectively storing an address ADDR of the first buffer memory 1400. Thus, it a storage device with an improved speed may be provided.

FIG. 7 is a block diagram schematically illustrating a buffer manager corresponding to a plurality of channels, according to an example embodiment of the inventive concepts. In one example embodiment, a memory controller 1200 may be connected with a flash memory 1300 based on a plurality of channels CH1 to CHn. Each of first and second buffer memories 2400 and 2500 may include a plurality of buffer memory units corresponding to the plurality of channels, respectively. For ease of description, components unnecessary to describe a buffer manager 2210 may be skipped.

Referring to FIGS. 6 and 7, a buffer manager 2210 may receive addresses ADDR_CH1 to ADDR_CHn, selection information SEL_{—}1 to SEL n, a read address ADDR_read and data from a memory controller 1200.

The buffer manager 2210 may include de-multiplexers 2211_1 to 2211_n, AND gates 2212_1 to 2212_n, a register 2213, comparators 2214_1 to 2214_n, a multiplexer 2215, an OR gate 2216, and an address de-multiplexer 2217.

The de-multiplexers 2211_1 to 2211_n, the AND gates 2212_1 to 2212_n, the register 2213, the comparators 2214_1 to 2214_n, and the multiplexer 2215 may operate substantially the same as described with reference to FIG. 6, and a description thereof is thus omitted.

The OR gate 2216 may logically combine outputs of the comparators 2214_1 to 2214_n. For example, if an address ADDR_CH1_reg stored at the register 2213 is equal to a read address ADDR_read, an output of the comparator 2214_1 may have a logically high level. Thus, the OR gate 2216 may output a high-level signal.

The multiplexer 2215 may output data stored at one of first and second buffer memories 2400 and 2500 based on an output of the OR gate 2216.

The buffer manager 2210 may store an address ADDR of the first buffer memory 2400 corresponding to the second buffer memory 2500 with respect to each of channels. The buffer manager 2210 may use the first buffer memory 2400 and the second buffer memory 2500 together by managing an address of the first buffer memory 2400 only. Thus, a storage device with an improved speed is provided.

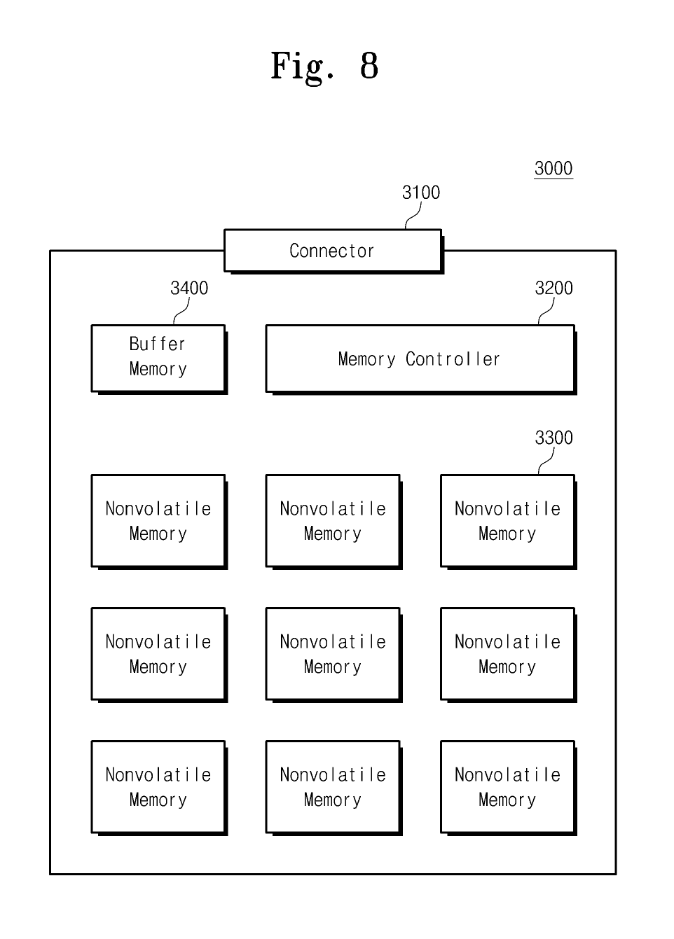

FIG. 8 is a block diagram schematically illustrating storage, according to an example embodiment of the inventive concepts.

Referring to FIG. 8, storage system 3000 may include a connector 3100, a memory controller 3200, a plurality of flash memories 3300, and a buffer memory 3400. The buffer memory 3400 may include different types of random access memories. The memory controller 3200 and the buffer memory 3400 may operate substantially the same as described above with reference to FIGS. 1-7

The connector 3100 may connect the storage system 3000 with a host. For example, the connector 3100 may be a connector of a standard interface used at the host. The connector 3100 may be a PCI-E based interface connector.

The storage system 3000 may be a solid state drive (SSD). The storage system 3000 may be connected with a host (e.g., a server, a main frame, etc.) requiring high-speed and mass storage.

According to the example embodiments of the inventive concepts, an operating speed of a second buffer memory may be higher than that of a first buffer memory. The second buffer memory may have data storage priority over the first buffer memory. Thus, a memory controller may store data read from a flash memory at the second buffer memory. If the memory controller does not store data read from the flash memory at the second buffer memory, it may store the read data at the first buffer memory. Also, the memory controller may use the first buffer memory and the second buffer memory together by managing an address of the first buffer memory only. Thus, it a flash memory based storage device with an improved speed is provided.

While the inventive concepts have been described with reference to some example embodiments, it will be apparent to those skilled in the art that various changes and modifications may be made without departing from the spirit and scope of the present subject matter. Therefore, it should be understood that the above example embodiments are non-limiting.

1. An operating method of a memory system including a flash memory, a first buffer memory, a second buffer memory and a memory controller, the operating method comprising:
reading data stored at the flash memory;
generating an address corresponding to a region of the first buffer memory at which the read data is to be stored;
determining whether the second buffer memory is at an erase state; and
if the determining indicates that the second buffer memory is at an erase state,
storing the read data at the second buffer memory, and
storing the generated address of the first buffer memory at an internal register.

2. The operating method of claim 1, further comprising
if the determining indicates that the second buffer memory is not at an erase state, storing the read data in a region of the first buffer memory corresponding to the stored address of the first buffer memory.

3. The operating method of claim 1, further comprising:
receiving a read address from a host;
comparing the read address and the stored address of the first buffer memory; and
transferring data corresponding to the read address to the host according to the comparing.

4. The operating method of claim 3, wherein the transferring comprises:
transferring data stored at the second buffer memory to the host, if the stored address of the first buffer memory is equal to the read address.

5. The operating method of claim 3, wherein the transferring comprises:
transferring data of the first buffer memory corresponding to the read address to the host, if the stored address of the first buffer memory is not equal to the read address.

6. The operating method of claim 3, wherein if the second buffer memory is not accessed during a period of time, the method further comprises:
flushing data stored at the second buffer memory to a region of the first buffer memory corresponding to the stored address of the first buffer memory.

7. The operating method of claim 4, wherein an operating speed of the second buffer memory is higher than an operating speed of the first buffer memory.

8. The operating method of claim 1, further comprising:
generating selection information indicating that the second buffer memory is at one of an erase state and a program state based on the determining.

9. A memory system, comprising:
a flash memory;
a first buffer memory; and
a memory controller configured to generate an address of the first buffer memory at which data read from the flash memory is to be stored, wherein
the memory controller comprises a second buffer memory; and a buffer manager,
the memory controller is configured to generate selection information indicating whether the second buffer memory is at one of an erase state and a program state, and
the buffer manager is configured to,
store the read data at one of the first buffer memory and the second buffer memory based on the selection information, and
store the generated address of the first buffer memory based on the selection information.

10. The memory system of claim 9, wherein the memory controller is further configured to flush the data stored at the second buffer memory to a region of the first buffer memory corresponding to the stored address of the first buffer memory, when the second buffer memory is not accessed during a period of time.

11. The memory system of claim 9, wherein the buffer manager comprises:
a de-multiplexer configured to,
receive the generated address of the first buffer memory, the read data and the selection information, and
select one of the first buffer memory and the second buffer memory based on at least the selection information;
a register configured to selectively store the address of the first buffer memory based on the selection information;
a comparator configured to compare the address stored at the register with the read address; and
a multiplexer configured to transfer data stored at the selected one of the first buffer memory and the second buffer memory to the host based on an output of the comparator.

12-14. (canceled)

15. The memory system of claim 9, wherein the memory controller is connected to a host based on a peripheral component interconnection-express (PCI-E) based interface.

16. A method comprising:
determining, for a memory system comprising a first buffer memory and a second buffer memory, a state of the second buffer memory, and
designating at least one of the first buffer memory and the second buffer memory for storing data based on the determined state of the second buffer memory.

17. The method claim 16, further comprising:
receiving a read data request from a host; and
reading data corresponding to the received read data request from a flash memory.

18. The method of claim 17, further comprising:
generating an address at the first buffer memory for storing the read data.

19. The method of claim 18, wherein the determining the state of the second buffer memory includes generating selecting information indicating whether the second buffer memory is at an erase state.

20. The method of claim 19, wherein the determining determines that the second buffer memory is at the erase state if the generated selection information is a logical 1.

21. The method of claim 19, wherein the designating designates the second buffer memory for storing the read data, if the generated selection information indicates that the second buffer memory is at the erase state.

22. The method of claim 18, wherein upon designating the second buffer memory for storing the read data, the method further includes:
determining an amount of time since the host last accessed the second buffer memory, and
flushing the data stored in the second buffer memory to a region of the first buffer memory corresponding to the generated address of the first buffer memory.

23. The method of claim 19, further comprising:
receiving the generated address of the first buffer memory, the read data and the generated selection information, and
selecting at least one of the first buffer memory and the second buffer memory based on at least the generated selection information;
selectively storing, at a register, the address of the first buffer memory based on the generated selection information;
comparing the selectively stored address with an address associated with the read data; and
transferring data stored at the selected one of the first buffer memory and the second buffer memory, to the host based on the comparing.

24-26. (canceled)
